(19) United States
(12) Patent Application Publication
(10) Pub. No.: US 2013/0035774 A1
(43) Pub. Date: Feb. 7, 2013

(54) SYSTEM AUTOMATION VIA AN ALARM SYSTEM

(71) Applicants: Jeremy Bruce Warren, Draper, UT (US); Todd Matthew Santiago, Provo, UT (US)

(72) Inventors: Jeremy Bruce Warren, Draper, UT (US); Todd Matthew Santiago, Provo, UT (US)

(73) Assignee: 2GIG TECHNOLOGIES, INC., Lehi, UT (US)

(21) Appl. No.: 13/567,999

(22) Filed: Aug. 6, 2012

Related U.S. Application Data
(60) Provisional application No. 61/515,027, filed on Aug. 4, 2011.

(51) Int. Cl. G06F 17/00

(52) U.S. Cl. 700/90

(57) ABSTRACT

Methods, devices, systems, and computer program products for automating a system based on weather data are disclosed. A method may comprise receiving weather related data and modifying at least one system rule at least partially based on the received weather related data. The method may also include conveying one or more commands to at least one system control based at least partially on the at least one modified system rule. Further, the method may include operating the at least one system in response to the one or more commands.

CLAIM OF PRIORITY UNDER 35 U.S.C. §119

The present application for patent claims priority to Provisional U.S. Application Ser. No. 61/515,027, entitled “SPRINKLER SYSTEM CONTROL VIA ALARM SYSTEM CONTROL PANEL,” filed Aug. 4, 2011, assigned to the assignee hereof, and expressly incorporated herein by reference.

### TECHNICAL FIELD

The present invention relates generally to system automation and, more specifically, to methods, devices, systems, and computer-readable media for system automation via alarm systems.

### BACKGROUND OF RELATED ART

Alarm systems are widely used to protect property and for personal safety. Alarm systems generally include a control panel, which controls the overall operation of the system, one or more keypads for user access to the system, and various detectors and sensors.

Alarm systems may generate an alarm in response to any number of events, such as unauthorized entry, fire, a medical emergency or manual alarm activation. Further, an alarm system may be associated with a service that remotely monitors the status of the alarm system. Thus, if the alarm system generates an alarm, a notification signal may be transmitted via a wired and/or wireless communications link to a central station. Upon receiving the notification signal, security service personnel at the central station may attempt to contact the property owner (i.e., the party at the secured location) to verify the alarm. If it is appropriate to do so, the security service personnel may, upon confirmation of the alarm, contact an emergency response agency (e.g., the police department, the fire department or an emergency medical team, etc.).

Alarm systems have therefore enhanced the ability of homeowners and businesses to monitor their premises and to protect against break-ins and the crimes that can accompany them (e.g., theft, damage to property, assault and battery, stalking, intrusion into privacy, etc.).

### BRIEF SUMMARY OF THE INVENTION

An alarm system according to the present disclosure includes a control system having an alarm system controller for receiving weather data from a weather data source and conveying one or more commands for controlling operation of one or more systems in response to the weather data. The control system may further include a system control for controlling the one or more systems in response to receiving the one or more commands from the alarm system controller.

In a specific embodiment, an alarm system controller may include an automation module for receiving forecast weather data and managing one or more rules of a remote system based on the received forecast weather data. The alarm system controller may further include an interface for transmitting one or more commands for controlling the remote system according to the one or more rules.

In another specific embodiment, a control system may include a control peripheral device having an interface for receiving one or more commands from an alarm system controller and transmitting a status of a system to the alarm system controller. The control peripheral may also include another interface for coupling to a system control for controlling the system in response to the one or more commands.

In yet another specific embodiment, An alarm system control panel that interfaces with a sprinkler system control, the alarm system control panel comprising: a wireless interface configured to establish a connection with a sprinkler system control and to transfer sprinkler system related data through the connection, including: receiving sprinkler status from the sprinkler system control, and sending one or more sprinkler commands to the sprinkler system control; a network interface configured to receive weather-related data from a network; and a sprinkler automation module configured to manage one or more sprinkler zones operated by the sprinkler system control.

Of course, methods of operating a system are also within the scope of the present invention. Such a method may include receiving weather related data and modifying at least one system rule at least partially based on the received weather related data. The method may further include conveying one or more commands to at least one system control based at least partially on the at least one modified system rule and operating the at least one system in response to the one or more commands.

In another specific embodiment, a method of operating a system may include receiving forecast weather data at an alarm system controller from a weather data source; and controlling at least one system via the alarm system controller based on the forecast weather data.

Another specific embodiment may include a method in which forecast weather data may be used to control operation of an irrigation system. The method may include establishing a wireless connection with a sprinkler system control, the wireless connection established to receive sprinkler status from the sprinkler system control and to send sprinkler commands to the sprinkler system control panel. The method may further include defining at least one sprinkler zone rule and developing a watering schedule from the at least one sprinkler zone rule, the watering schedule defining a time period during which at least one sprinkler zone should be active. Furthermore, the method may include receiving weather related data over a network interface, the weather related data including at least a forecast relating to one or more of future temperature, precipitation, or wind conditions. The method can also include modifying at least the watering schedule based on the received weather related data, including defining a different time period during which the at least one sprinkler zone should be active to optimize water usage in view of the forecast. Moreover, the method may include sending one or more sprinkler commands to the sprinkler system control panel over the wireless connection, the one or more sprinkler commands configured to cause the sprinkler system control panel to activate the at least one sprinkler zone as defined by modified at least the watering schedule.

Yet another embodiment of the present invention comprises a computer-readable media storage storing instructions that when executed by a processor cause the processor to perform instructions in accordance with one or more embodiments described herein.

Other aspects, as well as features and advantages of various aspects, of the present invention will become apparent to those of skill in the art though consideration of the ensuing description, the accompanying drawings and the appended claims.

### BRIEF DESCRIPTION OF THE FIGURES

FIG. 1 illustrates an embodiment of an alarm system;

FIG. 2 illustrates an embodiment of a system for operating a system control via an alarm system;

FIG. 3 illustrates an embodiment of a system for operating a sprinkler system control via an alarm system;

FIG. 4 is a flowchart illustrating an embodiment of a method in which forecast weather data may be used to control operation of an irrigation system; and

FIGS. 5 and 6 are flowcharts illustrating embodiments of methods in which forecast weather data is used to control operation of another system.

### DETAILED DESCRIPTION

Referring in general to the accompanying drawings, various aspects of the disclosed subject matter are illustrated to show the structure of an automation system and the process flow of automation methods. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of various aspects of the disclosed subject matter.

The following provides a more detailed description of various representative embodiments. In this description, functions may be shown in block diagram form in order not to obscure the disclosed embodiments in unnecessary detail. Additionally, block definitions and partitioning of logic between various blocks is exemplary of a specific implementation. It will be readily apparent to one of ordinary skill in the art that the disclosed subject matter may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

In various embodiments, methods, devices, systems, and computer-readable media for controlling one or more systems via an alarm system are disclosed. As an example, an alarm system may, in response to receipt of forecast weather data, control operation of a system, such as a heating, ventilation, and air-conditioning (HVAC) system or a sprinkler or irrigation system.

As noted above, an alarm system may include one or more sensors linked to a control panel, which may include an interface that can be used by a user. Via the control panel, a user may arm (e.g., when leaving their residence) and disarm (e.g., when entering their residence) the alarm system. The control panel may provide other functionality, such as a physical duress alarm, two-way voice communication, a siren, etc. Alarm sensors may be configured to monitor for various events. For example, a door/window sensor may be configured to detect when a door/window has been opened, a motion detector may be configured to detect motion. Other sensors may be configured to detect breaking of glass.

In addition to a local control panel, which monitors sensor activity on premises, an alarm system may include a central monitoring system. For residential alarm systems, a remote central monitoring system can be a third party vendor's in some cases, the same company that installed the alarm system. For commercial and industrial alarm systems, security or other personnel may monitor the premises. In commercial and industrial settings, the control panel can be integrated into a larger security system. In any event, when sensor monitoring is activated and a sensor indicates a physical disturbance, the control panel can activate an alarm. In response to an alarm, the control panel can activate an audible siren and/or send an indication of the alarm to a central monitoring entity via an alarm event signal. The central monitoring entity can then initiate a response, such as contacting the owner of the premises, sending security personnel, contact authorities, or a combination thereof.

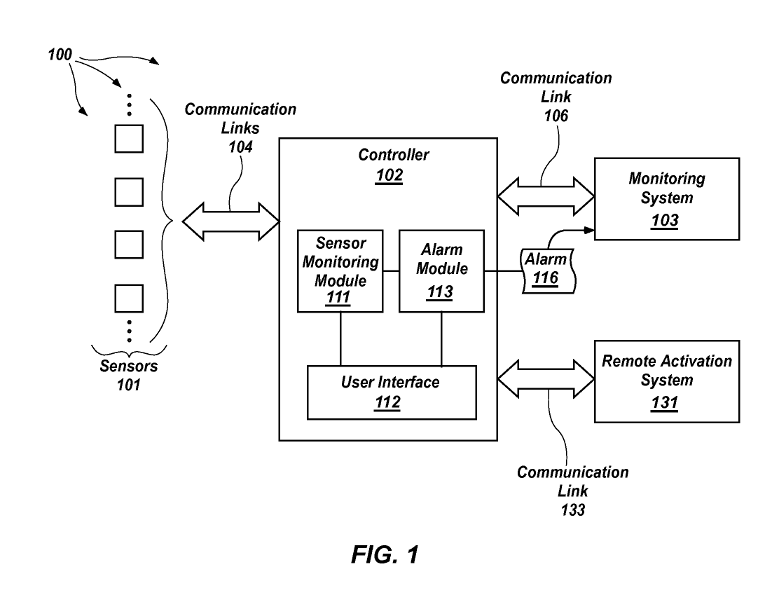

FIG. 1 illustrates an embodiment of an alarm system 100. Alarm system 100 includes sensors 101, controller 102, monitoring system 103, and remote activation system 131. Communication links 104 (e.g., a combination of wired and wireless communication links) couple sensors 101 to controller 102. Wired communication links can include circuit loops that are either detected as closed or open. In some embodiments, sensors 101 and controller 102 are located on the same premises, such as in the same residence or in the same building. Communication link 106 (e.g., a wired telephone connection, wired or wireless network connection, cellular connection, etc., or combination thereof) couples controller 102 to monitoring system 103.

Generally, sensors 101 include any of a variety of different types of sensors, such as door and window sensors, motion sensors, glass break sensors (e.g., detecting a physical break or detecting the sound of a glass break), etc. Generally, controller 102 is configured to monitor sensors 101 for alarm conditions via communication links 104 and relay alarms to monitoring system 103 via communication link 106.

Controller 102 includes sensor monitoring module 111, user interface 112, and alarm module 113. Sensor monitoring module 111 is configured to monitor sensors 101. Sensors 101 can sense and/or indicate a change in their physical surroundings (e.g., a normally closed connection becomes open, a signal indicating that the sound of breaking glass was detected, etc.), which may be indicative of an unauthorized access, on communication links 104. For example, a circuit connected to a door sensor can transition from closed to open (or at least to a resistance exceeding a pre-determined resistance threshold) indicating that a door has been opened. A motion sensor can send an electrical signal indicative of detected motion. Sensor monitoring module 111 may monitor communication links 104 for indications and signals sent from sensors 101. Upon sensor monitoring module 111 receiving an indication or signal of a change in physical surroundings, sensor monitoring module 111 may send the indication or signal to alarm module 113. When appropriate, alarm module 113 can treat a monitored indication or signal from a sensor as an alarm condition.

User interface 112 can include an input interface and an output interface. The input interface can comprise a physical input interface or virtual input interface that includes one or more a numeric key pad (e.g., for entering a disarm code, etc.), sensor activation buttons, physical duress buttons, etc. The input interface can also include a condenser for receiving audio input and/or communicating with monitoring system 103. The output interface includes an output display device that display system status, such as armed, disarmed, sensors/zones that have detected change in physical surroundings, etc. The output interface can also include a speaker that audibly outputs information similar to that displayed on the output display device. The speaker can also be used by monitoring system 103 to communicate with a user of controller 102.

In addition to providing security, an alarm system (e.g., alarm system 100, etc.) may operate as an automated system configured to control one or more systems in response to data received from a remote source. More specifically, according to one embodiment, an alarm system may, in response to received weather data (e.g., forecast weather data), control one or more devices of a heating, ventilation, and air conditioning (HVAC) system. It is noted that weather data may comprise, for example only, temperature, wind speed and direction, precipitation, humidity, sunrise and sunset times, air quality, ozone level, and cloud cover.

According to one embodiment, the alarm system may include a control panel including a transceiver (e.g., a wireless transceiver, etc.). The transceiver may be configured to receive weather data from a weather data source and transmit commands to a system controller for controlling operation of an associated system. More specifically, the transceiver may be configured to communicate with a control peripheral (e.g., a wireless control peripheral, etc.) that interfaces with a system control of the associated system. The control peripheral may supplement or take over the command functionality. Alternatively, the alarm system control panel may communicate directly with the system control without use of a control peripheral.

The alarm system control panel includes a hardware and/or software-based system automation module that is configured to receive a status from the system control via the transceiver. The system automation module creates and manages one or more systems and sends commands to the system control via the transceiver based on rules. The system automation module may also be configured to communicate via a hard-wired or wireless network interface at the alarm system control panel with one or more computing devices connected to a network, such as a local area network (LAN), a wide area network (WAN), or the Internet. This enables the system automation module to receive pertinent information, such as local weather data, from an external source, and to communicate with one or more remote computing devices. Thus, the system automation module can consider a host of factors, including past, current, and future weather conditions or climate data, when managing the system control.

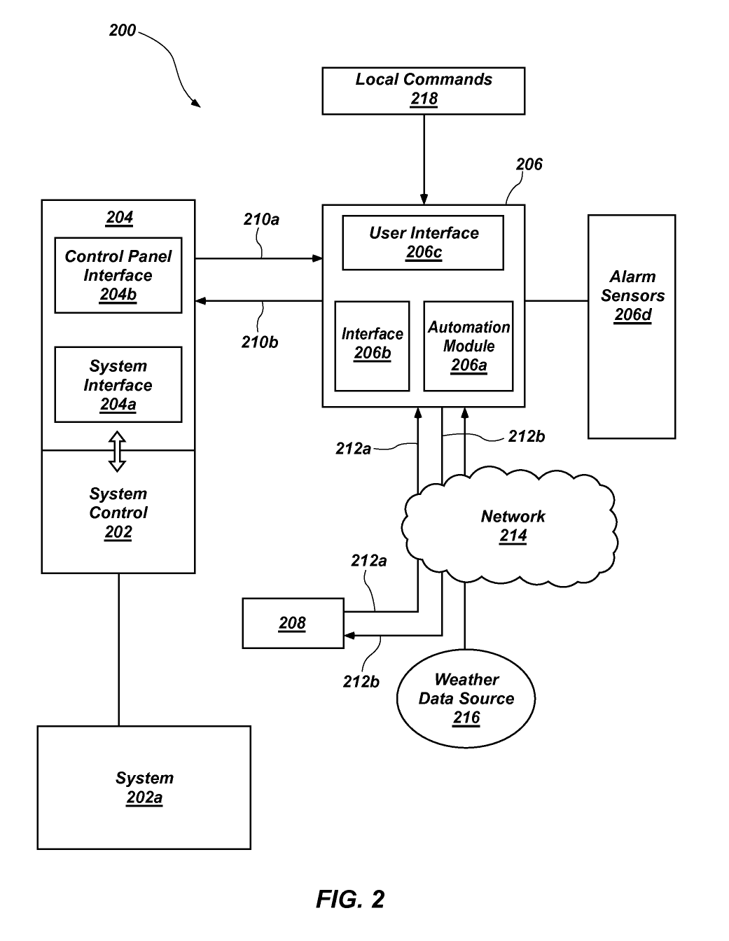

FIG. 2 illustrates an embodiment of a system 200 in which an alarm system control panel 206 affects operation of an associated system 202a. As depicted, system 200 includes a system control 202 (e.g., a computerized device control panel), a control peripheral 204 that interfaces with the system control 202, and alarm system control panel 206 that communicates with the control peripheral 204. It is noted that alarm system control panel 206 may also be referred to herein as an “alarm system controller” or an “automation controller.” As non-limiting examples, system 202a may comprise an HVAC system (e.g., heating, ventilation, and/or air conditioning device), a lighting system, a swimming pool system, or a sprinkler system.

Whereas conventional system controls (e.g., HVAC control, etc.) are exclusively managed using a dedicated control panel (e.g., a thermostat), the system 200 of FIG. 2 integrates a conventional system control 202 with an alarm system control panel 206, and manages system 202a through the alarm system control panel 206. Managing system 202a centrally using alarm system control panel 206 integrates system management into a larger home automation scheme and makes efficient use of system 202a. For instance, as illustrated in FIG. 2, the alarm system control panel 206 is connected to a network 214, such as a LAN, a WAN, or the Internet, and is configured to receive information from a weather data source 216, through the network 214. Using data from weather data source 216, alarm system control panel 206 can make intelligent and proactive decisions about operation of system 202a. Furthermore, in addition to managing system 202a locally (e.g., at the system control 202 and/or at alarm system control panel 206) a user (e.g., a home or business owner) can use system 200 to manage and monitor system 202a remotely over the network 214 using a remote computing device 208.

Referring initially to system control 202, system control 202 can, in one or more embodiments, comprise a conventional computerized system control panel that controls operation of system 202a. System 200 can be built around an existing system control panel without replacing the potentially costly system control hardware. System control 202 is configured to operate system 202a. Standing on its own, system control 202 would typically use one or more user-defined settings and schedules that control, on a day-by-day or recurring basis, system 202a. These settings, however, may be largely static and permit only limited flexibility, such as adjusting on/off times of system 202a and/or durations based on preprogrammed adjustments. This limited flexibility may cause conventional system controls to operate system 202a during sub-optimal periods of time in light of actual real-time environments. Furthermore, conventional computerized system controls require physical presence of an operator at a control panel to interact with system 202a, (e.g., to view status, to define or modify settings, to manually operate system 202a, etc.).

As shown, one or more embodiments of the invention address these deficiencies by integrating a control peripheral 204 with system control 202 and with the alarm system control panel 206. As indicated by the double-ended arrow, the control peripheral 204 is configured to communicatively interface with system control 202. The particular manner in which the control peripheral 204 interfaces with system control 202 can vary depending on the architecture of system control 202. For instance, in some implementations, the control peripheral 204 may communicatively interface with system control 202 via a hard-wired serial interface (e.g., RS-232, I2C, SPI, etc.). Any other appropriate communicative interface is also within the scope of the present invention.

Control peripheral 204 includes a hardware and/or software-based system interface 204a that is configured to send commands to system control 202, and to receive status information from system control 202. In some embodiments, the control peripheral 202 can be configured, through system interface 204a, to take over substantially all functionality of system control 202. In such embodiments, the system control 202 may merely respond to commands from system interface 204a to operate system 202a. In other embodiments, system interface 204a can be configured to supplement existing functionality of system control 202, such as to modify one or more settings, schedules, or both, at system control 102.

Control peripheral 204 also includes an interface 204b that is configured to wirelessly communicate with a corresponding interface 206b at alarm system control panel 206. Thus, control peripheral 204b is configured to transmit system status (i.e., a status of system 202a) to the alarm system control panel 206, and to receive system commands from alarm system control panel 206. Control peripheral 204 can be configured to send the system status at pre-defined intervals or in response to a particular request by alarm system control panel 206 (as part of the system commands, for example). The system status can include any combination of status information available from system control 202. The system status can include, for instance, current setting information, historical runtime information, system data about system control 202 (e.g., model information, version information, etc.), system hardware information (e.g., the identity of sprinklers, valves, etc.), and the like.

As mentioned, the control peripheral 204 is configured to receive system commands from the alarm system control panel 206 via interface 204b. The system commands 110b can then be passed, via system interface 204a, to system control 202. In situations where the control peripheral 204 takes over substantially all functionality of the system control 202, the commands can directly instruct the control system 202 to operate system 202a. Alternatively, in situations where the control peripheral 204 supplements functionality of the system control 202, the commands may be used to re-program functionality, such as schedules and settings, of the control system 202. System interface 204a can perform any conversion appropriate to facilitate communications between system control 202 and alarm system control panel 206 (e.g., converting system status and/or system commands, etc.).

In one or more embodiments, system control 202 and control peripheral 204 can be combined as a single unit. Thus, instead of control peripheral 204 taking over or supplementing functionality of the system control 202, system control 202 can itself be configured to communicate with alarm system control panel 206 (e.g., by including a wireless interface) to send system status to alarm system control panel 206 and to receive system commands from alarm system control panel 206. Such an embodiment may be useful when initially installing a system control that integrates with alarm system control panel 206, instead of adding this functionality to an already existing system control.

Using control peripheral 204, alarm system control panel 206 can centrally manage and control system control 202. Alarm system control panel 206 can comprise functionality typical of an alarm system control panel. As shown, for instance, alarm system control panel 206 is configured to interface with one or more alarm sensors 206d which can detect physical disturbances on the premises, such as those that would signal possible break-in attempts. Alarm sensors 206d can also detect other potentially dangerous situations, such as fire, flood, etc.

As illustrated, however, alarm system control panel 206 is also configured to interface with and control system control 202 via control peripheral 204. As mentioned, alarm system control panel 206 includes interface 206b for receiving system status from system control 202, and for sending system commands to the system control 202.

Alarm system control panel 206 includes a hardware and/or software-based system automation module 206a, which is configured to intelligently and dynamically manage operation of system control 202. At a basic level, system automation module 206a processes received system status and sends system commands 210b to control peripheral 204. The status can include any of the system control 202 status indicated above. The system commands can comprise commands that directly instruct the system control 202 to operate.

In one or more embodiments, system automation module 206a stores and manages schedules and settings (“rules”) of system 202a at alarm system control panel 206. The rules at the alarm system can either supplement (e.g., modify, etc.) or replace rules implemented by programmed into system control 202. In one or more embodiments, the rules determined at control panel 206 can be based on rules at system control 202. The rules at control panel 206 can be defined or modified with local system commands 218 that are received directly at the alarm system control panel 206. For instance, user interface 206c, hardware and/or software modules or components at alarm system control panel 206 can be used to receive the local system commands 218. For example, alarm system control panel 206 can include display devices and input devices (e.g., buttons, switches, touch-sensitive devices). As disused in more detail later, the rules also be defined or modified via remote commands 212a received over the network 214 from a remote computing device 208.

Similar to conventional rules at the system control 202, the rules at alarm system control panel 206 can also define operation times and durations on a day-by-day or recurring basis, and can adapt for forecast weather data and pre-defined seasonal or daily adjustments. However, the rules at the alarm system control panel 106 can also detect and account for a host of other factors, both historical and prospective. As illustrated, for example, alarm system control panel 206 can be configured to receive information (i.e., weather data) from weather data source 116, over the network 214. The information can include past, current, and future weather and/or climate information. For example, the information can include data about historical averages (e.g., maximum, minimum, and/or average rainfall, temperature, humidity, etc.), currently measured weather data (e.g., current temperature, humidity, cloud cover, precipitation, wind, and other measured data, etc.), and/or predicted weather data (e.g., forecast maximum and minimum temperatures, forecast cloud cover, forecast humidity, forecast precipitation, forecast winds, and the like). Based on such information, system automation module 206a may be configured to prospectively adjust rules and setting for associated system 202a.

System automation module 206a may be configured to cause system control 202 to operate associated system 202a in conformity with any modifications made to rules or schedules (due to the local weather data, for example). For instance, system automation module 206a can be configured to send specific system commands 210b to system control 202 that directly instruct system control 202 to operate associated system 202a. Alternatively, system automation module 206a can be configured to send system commands to system control 202 that cause system control 202 to modify rules at system control 202 to reflect a modified operation schedule.

As illustrated, alarm system control panel 206 may be configured to communicate bi-directionally with one or more remote computing devices 208 through network 214, by sending system related data 212b to the remote computing device(s) 208, and by receiving remote commands 212a from remote computing device 208. For example, remote computing device 208 (e.g., a web and/or a mobile clients, etc.) can receive system related data 212b regarding present system status, historical system usage, current rules and settings, weather-related adjustments, etc. Remote computing device 208 can then present this information to a user via one or more user interfaces. The user interface(s) can present the information in any appropriate form, including the use of spreadsheets, calendars, graphical icons, charts, graphs, lists, maps, etc. In some embodiments, the user interface(s) displayed at remote computing device 208 is (are) generated by the remote computing device 208 itself, while in other embodiments the user interface(s) is (are) generated, at least in part, with the assistance of the user interface 206c module or component at alarm system control panel 206. Thus, alarm system control panel 206, by communicating with remote computing device 208 over the network 214, can enable a user to access system related data (i.e., data related to system 202) from virtually any location.

In one or more embodiments, user interface(s) at alarm system control panel 206 or at remote computing device(s) 208 can be configured to present a user with detailed information about past system usage patterns, projected system usage (based on historical data, local weather data, etc), projected usage costs, and the like.

The user interface(s) at remote computing device(s) 208 can be configured to enable remote user input. Thus, a user can enter, or cause to be generated, remote system commands 212a. These commands can influence all aspects of control of system control 102. For instance, the remote commands 212a can be used to define or modify schedules or settings (at the alarm system control panel 206 or at control system 202), to override schedules or settings, or to manually operate associated system 202a. For instance, remote computing device 208 might receive, as part of system related data 212b, a current operating schedule which includes a dynamic modification based on the local weather data. Remote computing device 208 can display this operating schedule to the user and the user can choose to override the schedule. A homeowner may, for example, choose to override the operating schedule due to various factors, such as cost, need, etc.

Thus, alarm system control panel 206, by interfacing with network 214 and exchanging system related data 212b and remote system commands 212a, enables users to interact with their sprinkler system from remote devices, where they may view status and programming information, manually turn associated system 202a on/off, adjust programming settings, override automatic schedule adjustments, etc.

In one or more embodiments, system automation module 206a and/or remote computing device 208 can send a user alerts or other system-related information. For instance, a user may be notified (e.g., via an e-mail, a SMS message, or other alert) when settings or schedules have been dynamically modified, if associated system 202a or system control 202 has malfunctioned, when electricity use has exceeded or is about to exceed predefined levels, etc. It will be appreciated that these are only a few of the alerts that may be sent, and that any system-related alert falls within this disclosure.

In one or more embodiments, the alarm system control panel 206 can be configured to adjust schedules to prorate application of a fixed amount of electricity over a period of time. For instance, alarm system control panel 206 can ensure that system 202a only uses a predefined amount of electricity each month. The amount of electricity allocated for each month can vary from month to month based on factors such as past climate data, predicted weather patterns, etc. This information can be obtained via user input information or via a database.

In one or more embodiments, alarm system control panel 206 can be configured to track the service life of components of associated system 202a. For instance, alarm system control panel 206 can track usage of components of associated system 202a that are prone to wear. Alarm system control panel 206 can be configured to compare the usage information with known service life data for the components to make maintenance recommendations. Alarm system control panel 206 can also be configured to send notification of regular maintenance, such as checking for dirty or clogged filters, checking for proper adjustment of sprinkler heads, checking refrigerant levels, checking for dirty burners, checking for a cracked heat exchanger, etc.

The invention has been described in the context of system 200, in which alarm system control panel 206 maintains operation schedules and in which alarm system control panel 206 sends commands through a system control 202 to a control peripheral 204 for controlling an associated system 202a. It will be appreciated, however, that system 200 can be modified without departing from the spirit and scope of the present invention. For instance, the system automation module 206a may, in one or more embodiments, be integrated into control peripheral 204 instead of alarm system control panel 206. Thus, in one or more embodiments operating decisions may be made at control peripheral 204 instead of alarm system control panel 206.

As noted above, associated system 202a may comprise a sprinkler systems or an irrigation system. As will be appreciated, many homeowners and businesses use sprinkler system controls to automate the use of sprinkler systems when irrigating lawns, trees, flower beds, or other landscaping elements. Sprinkler systems are typically divided into one or more sprinkler zones, with each zone comprising one or more water distribution devices (e.g., sprinklers, drip devices, etc.). The flow of water to each zone in the sprinkler system is typically controlled using one or more valves. Sprinkler system controls make use of digital or analog circuitry, or even mechanical timers, to programmatically actuate these valve(s) and to, in turn, regulate the flow of water to the sprinkler zones. Sprinkler system controls therefore enable a user to program, via user input at a sprinkler system control panel, one or more programmatic rules that control the flow of water to the sprinkler zones. Typical rules control the duration of operation of each zone, an order of operation of the zones, and days on which the zones are to operate, for example. By way of illustration, a simple sprinkler system might have two zones (e.g., zone one and zone two). For this sprinkler system, a user might create rule(s) that operate zone one for ten minutes and zone two for five minutes starting at 9:00 PM on Monday, Wednesday, and Friday.

Some sprinkler system controls can include more advanced scheduling functionality. For instance, some sprinkler system controls may communicate with a rain sensor that can detect past or present rainfall. Using the rain sensor, the sprinkler system control may make a decision to forego or modify execution of one or more rules. For instance, if it is determined, based on the rain sensor, that it is currently raining or that it has recently rained, the sprinkler system control may make a decision to forego watering one or more zones. Furthermore, based on one or more of calendar dates, detected rainfall, or even manual user input, some sprinkler system controls may make adjustments to the duration of operation of one or more sprinkler zones (e.g., a seasonal adjustment, etc.).

Sprinkler system controls have eased the burden involved in operating sprinkler systems, as these sprinkler systems can operate largely without user input once the system controls have been initially configured. Furthermore, sprinkler system controls reduce the amount of water consumed during watering by reducing the amount of human error involved in timing operation of sprinkler systems, by considering past or current rainfall, and by making seasonal adjustments to watering duration. Despite these advances, however, sprinkler system controls can be difficult to operate and monitor, requiring personal presence at the sprinkler system control panel. Furthermore, zone configuration rules are rigidly applied, and fail to consider factors beyond past or current rainfall or pre-programmed adjustments.

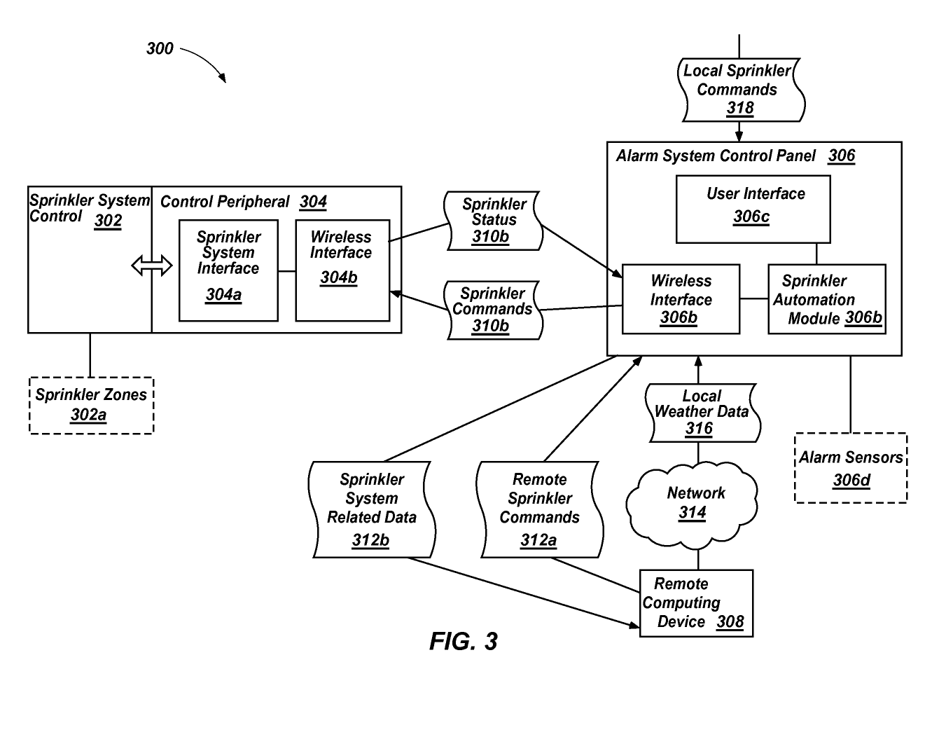

FIG. 3 illustrates an embodiment of an irrigation control system 300 for wirelessly operating a sprinkler system control via an alarm system control panel. As depicted, the irrigation control system 300 includes a sprinkler system control 302 (e.g., a computerized sprinkler system control panel, etc.), a control peripheral 304 that interfaces with the sprinkler system control 302, and an alarm system control panel 306 that communicates with the control peripheral 304. It is noted that alarm system control panel 306 may also be referred to herein as an “alarm system controller.”

Whereas conventional sprinkler system controls are exclusively managed using a dedicated control panel (e.g., sprinkler system control 302), irrigation control system 300 integrates a conventional sprinkler system control 302 with an alarm system control panel 306, and manages the sprinkler system through the alarm system control panel 306. Managing sprinkler systems centrally using the alarm system control panel 306 integrates sprinkler system management into a larger home automation scheme and makes efficient use of the sprinkler system. For instance, as illustrated in FIG. 3, the alarm system control panel 306 is connected to a network 314, such as a LAN, a WAN, or the Internet, and is configured to receive information, such as local weather data 316, through the network 314. Using the local weather data 316, the alarm system control panel 306 can make intelligent and proactive decisions about watering schedules, leading to more efficient use of limited water resources than is typically achieved using a sprinkler system control 302 alone, while requiring less user attention to manage the watering. Furthermore, in addition to managing watering schedules and monitoring sprinkler status locally (e.g., at the sprinkler system control 302 and/or at the alarm system control panel 306) a user (e.g., a home or business owner, etc.) can use irrigation control system 300 to manage and monitor a sprinkler system remotely over the network 314 using a remote computing device 308.

The sprinkler system control 302 can, in one or more embodiments, comprise a conventional computerized sprinkler system control panel that controls operation of one or more sprinkler zones 302a of a sprinkler system. Thus, irrigation control system 300 can be built around an existing sprinkler system control panel without replacing the potentially costly sprinkler control hardware. The sprinkler system control 302 is configured to operate one or more valves associated with sprinkler zones 302a to control the flow of water to the zones. Standing on its own, sprinkler system control 302 would typically use one or more user-defined zone rules that control, on a day-by-day or recurring basis, operating times and durations of operation of each of the sprinkler zones 302a. These zone rules, however, are largely static and permit only limited flexibility, such as adjusting watering times and/or durations based on preprogrammed seasonal adjustments, or based on detected rainfall. This limited flexibility causes conventional sprinkler system controls to operate irrigation systems during sub-optimal periods of time, such as during hotter time periods and/or before rainstorms, leading to potentially significant waste of water resources. Furthermore, conventional computerized sprinkler system control panels require physical presence of an operator at the control panel to interact with the irrigation system, (e.g., to view status, to define or modify zone rules, to manually operate zones, etc.).

As shown, one or more embodiments of the invention address these deficiencies by integrating a control peripheral 304 with the sprinkler system control 302 with alarm system control panel 306. As indicated by the double-ended arrow, the control peripheral 304 is configured to communicatively interface with the sprinkler system control 302. The particular manner in which control peripheral 304 interfaces with sprinkler system control 302 can vary depending on the architecture of the sprinkler system control 302. For instance, in some implementations, control peripheral 304 may communicatively interface with sprinkler system control 302 via a hard-wired serial interface (e.g., RS-232, I2C, SPI, etc.). Any other appropriate communicative interface is also within the scope of the present invention.

Control peripheral 304 includes a hardware and/or software-based sprinkler system interface 304a that is configured to send commands to the sprinkler system control 302, and to receive sprinkler status information from sprinkler system control 302. In some embodiments, control peripheral 302 can be configured, through the sprinkler system interface 304a, to take over substantially all functionality of sprinkler system control 302. In such embodiments, sprinkler system control 302 may merely respond to commands from sprinkler system interface 304a to operate sprinkler zones 302a. In other embodiments, sprinkler system interface 304a can be configured to supplement existing functionality of the sprinkler system control 302, such as to modify zone rules at the sprinkler system control 302.

Control peripheral 304 also includes a wireless interface 304b that is configured to wirelessly communicate with a corresponding wireless interface 306b at alarm system control panel 306. Thus, control peripheral 304b is configured to transmit sprinkler status 310a to alarm system control panel 306, and to receive sprinkler commands 310b from the alarm system control panel 306. Control peripheral 304 can be configured to send sprinkler status 310a at pre-defined intervals or in response to a particular request by alarm system control panel 306 (as part of sprinkler commands 310b, for example). Sprinkler status 310a can include any combination of status information available from sprinkler system control 302. Sprinkler status 310a can thus include, for instance, currently operating zone information, historical zone runtime information, pressure information, flow rate information, valve state information, error or exception information, detected rainfall information, sprinkler zone rules as programmed into sprinkler system control 302, system data about sprinkler system control 302 (e.g., model information, version information, etc.), zone configuration and layout information, irrigation system hardware information (e.g., the identity of sprinklers, valves, etc.), and the like.

As mentioned, control peripheral 304 is configured to receive sprinkler commands 310b from alarm system control panel 306 via wireless interface 304b. Sprinkler commands 310b can then be passed, via sprinkler system interface 304a, to sprinkler system control 302. In situations where control peripheral 304 takes over substantially all functionality of sprinkler system control 302, sprinkler commands 310b can directly instruct sprinkler control system 302 to operate one or more of sprinkler zones 302a. Alternatively, in situations where control peripheral 304 supplements functionality of sprinkler system control 302, sprinkler commands 310b may be used to re-program functionality of sprinkler system control 302, such as zone rules. Sprinkler system interface 304a can perform any conversion appropriate to facilitate communications between sprinkler system control 302 and alarm system control panel 306 (e.g., converting sprinkler status 310a and/or sprinkler commands 310b).

In one or more embodiments, sprinkler system control 302 and control peripheral 304 can be combined as a single unit. Thus, instead of control peripheral 304 taking over or supplementing functionality of sprinkler system control 302, sprinkler system control 302 can itself be configured to communicate with alarm system control panel 306 (e.g., by including a wireless interface, etc.) to send sprinkler status 310a to alarm system control panel 306 and to receive sprinkler commands 310b from alarm system control panel 306. Such an embodiment may be useful when initially installing a sprinkler system control 302 that integrates with the alarm system control panel 306, instead of adding this functionality to an already existing sprinkler system control.

Using control peripheral 304, alarm system control panel 306 can centrally manage and control sprinkler system control 302. Alarm system control panel 306 can comprise functionality typical of an alarm system control panel. As shown, for instance, alarm system control panel 306 is configured to interface with one or more alarm sensors 306d which can detect physical disturbances on the premises, such as those that would signal possible break-in attempts. Alarm sensors 306d can also detect other potentially dangerous situations, such as fire, flood, etc.

As illustrated, alarm system control panel 306 may also be configured to interface with and control sprinkler system control 302 via control peripheral 304. As mentioned, alarm system control panel 306 includes a wireless interface 306b for receiving sprinkler status 310a from sprinkler system control 302, and for sending sprinkler commands 310b to sprinkler system control 302.

Alarm system control panel 306 includes a hardware and/or software-based sprinkler automation module 306a, which is configured to intelligently and dynamically manage operation of sprinkler system control 302. At a basic level, sprinkler automation module 306a processes received sprinkler status 310a and sends sprinkler commands 310b to control peripheral 304. The status can include any sprinkler system control 302 status indicated above. The sprinkler commands can comprise commands that directly instruct sprinkler system control 302 to operate one or more of sprinkler zones 302a, or commands that modify zone rules at sprinkler system control 302.

In one or more embodiments, sprinkler automation module 306a stores and manages one or more sprinkler zone rules at alarm system control panel 306. The zone rules at the alarm system can either replace or supplement zone rules at sprinkler system control 302. In one or more embodiments, the zone rules at the alarm system can be based on zone rules at sprinkler system control 302. The zone rules at the alarm system can be defined or modified with local sprinkler commands 318 that are received directly at alarm system control panel 306. For instance, user interface 306c hardware and/or software modules or components at alarm system control panel 306 can be used to receive local sprinkler commands 318. For example, alarm system control panel 306 can include display devices and input devices (e.g., buttons, switches, touch-sensitive devices, etc.). As discussed in more detail hereafter, the zone rules can also be defined or modified via remote sprinkler commands 312a received over network 314 from a remote computing device 308.

Similar to conventional zone rules at sprinkler system control 302, the zone rules at alarm system control panel 306 can also define zone operations times and durations on a day-by-day or recurring basis, and can adapt for detected rainfall and pre-defined seasonal adjustments. However, zone rules at the alarm system control panel 306 can also detect and account for a host of other factors, both historical and prospective. As illustrated, for example, alarm system control panel 306 can be configured to receive information, such as local weather data 316, over network 314. Local weather data 316 can include past, current, and future weather and/or climate information. For example, local weather data 316 can include data about historical averages (e.g., maximum, minimum, and/or average rainfall, temperature, humidity, etc.), currently measured weather data (e.g., current temperature, humidity, cloud cover, precipitation, wind, and other measured data), and/or predicted weather data (e.g., forecast maximum and minimum temperatures, forecast cloud cover, forecast humidity, forecast precipitation, forecast winds, and the like). Based on local weather data 316, sprinkler automation module 306a be configured to prospectively adjust watering times and durations for sprinkler zones 302a. This can involve sprinkler automation module 306a modifying the zone rules at the alarm system, or merely modifying a watering schedule that is generated or modified based on the rules.

For example, sprinkler automation module 306a may be configured to make a determination, based on historical averages, that a future period of time is likely to be hot and dry. With this information, sprinkler automation module 306a can increase one or more of the duration or the frequency of operation of one or more sprinkler zones to provide additional water to plants during this period. As another example, sprinkler automation module 306a may be configured to make a determination, due to a future weather forecast of a rainstorm or heavy winds, that one or more sprinkler zones should not be operated during a period when they would normally operate to save water. As yet another example, sprinkler automation module 306a may be configured to modify the watering schedule so that one or more sprinkler zones operate during a period of time that will be cooler than another period of time, making a more efficient use of water. In some embodiments, local weather data 316 can be used to protect the sprinkler system and/or vegetation from freezing. For instance, if local weather data 316 indicates that the temperature will likely drop below freezing during a future period or time, the watering schedule can be modified to operate the sprinkler system during that period of time. One will appreciate, in view of this disclosure, that these are but a few examples of modifications to watering schedules that can be applied based on local weather data 316. Any modifications of watering schedules based on local weather data 316 fall within the scope of the disclosed subject matter.

Sprinkler automation module 306a is configured to cause sprinkler system control 302 to operate sprinkler zones 302a in conformity with any modifications made to rules or watering schedules (due to local weather data 316, for example). For instance, sprinkler automation module 306a can be configured to send specific sprinkler commands 310b to sprinkler system control 302 that directly instruct the sprinkler system control 302 to operate sprinkler zones 302a. Alternatively, sprinkler automation module 306a can be configured to send sprinkler commands 310b to sprinkler system control 302 that cause sprinkler system control 302 to modify zone rules at sprinkler system control 302 to reflect a modified watering schedule.

As illustrated, alarm system control panel 306 is configured to communicate bi-directionally with one or more remote computing devices 308 through network 314, by sending sprinkler system related data 312b to each remote computing device 308, and by receiving remote sprinkler commands 312a from one or more remote computing devices 308. For example, a remote computing device 308 (e.g., a web client, a mobile client, etc.) can receive sprinkler system related data 312b regarding present sprinkler status, historical watering data, flow and pressure information, current zone rules, weather-related watering adjustments, etc. Remote computing device 308 can then present this information to a user via one or more user interfaces. The user interfaces can present the information in any appropriate form, including the use of spreadsheets, calendars, graphical icons, charts, graphs, lists, maps, etc. In some embodiments, the user interface(s) displayed at remote computing device 308 are generated by remote computing device 308 itself, while in other embodiments the user interface(s) are generated, at least in part, with the assistance of user interface 306c module or component at alarm system control panel 306. Thus, alarm system control panel 306, by communicating with remote computing device(s) over network 314, can enable a user to access sprinkler system related data from virtually any location.

In one or more embodiments, user interface(s) at alarm system control panel 306 or at each remote computing device 308 can be configured to present a user with detailed information about past watering and water usage patterns, with projected water usage and/or projected watering schedules (based on combinations historical watering data, local weather data 314, etc), projected watering costs, and the like.

The user interface at remote computing device 308 can be configured to enable remote user input. Thus, a user can enter, or cause to be generated, remote sprinkler commands 312a. These remote sprinkler commands 312a can influence all aspects of control of irrigation control system 300. For instance, remote sprinkler commands 312a can be used to define or modify zone rules (at alarm system control panel 306 or at sprinkler system control 302), to override zone rules, to override dynamically-modified watering schedules, or to manually operate sprinkler zones. For instance, a remote computing device 308 might receive, as part of sprinkler system related data 312b, a current watering schedule which includes a dynamic modification based on local weather data 316. Remote computing device 308 can display this watering schedule to the user, and then the user can choose to override the schedule. A homeowner may, for example, choose to override the watering schedule because the modified schedule conflicts with the homeowner's use of the homeowner's yard. Additionally or alternatively, a user may prospectively provide a so called “black list” of times during which watering is prohibited or should be avoided.

Thus, alarm system control panel 306, by interfacing with network 314 and exchanging sprinkler system related data 312b and remote sprinkler commands 312a, enables users to interact with their sprinkler system from remote computing devices 308, where they may view status and zone programming information, manually turn zones on/off, adjust programming settings, override automatic schedule adjustments, etc.

In one or more embodiments, sprinkler automation module 306a and/or remote computing device 308 can send a user alerts or other sprinkler system-related information. For instance, a user may be notified (e.g., via an e-mail, a SMS message, or other alert) when zone rules or the watering schedule has been dynamically modified, when the sprinkler system has malfunctioned, when water flow rates are abnormal when compared to preprogrammed or measured norms (indicating the possibility of leaks, broken pipes, clogged sprinkler heads, etc.), when water use has exceeded or is about to exceed predefined levels, when the sprinkler system should be either purged or run to avoid the possibility of freezing, etc. It will be appreciated that these are only a few of the alerts that may be sent, and that any sprinkler system-related alert falls within this disclosure.

In one or more embodiments, alarm system control panel 306 can be configured to adjust watering schedules so that they prorate application of a fixed amount of water over a period of time. For instance, alarm system control panel 306 can ensure that the sprinkler system only uses a predefined amount of water each month. The amount of water allocated for each month can vary from month to month based on factors such as past climate data, predicted weather patterns, water costs, local ordinances, etc. This information can be obtained via user input information or via a database.

In one or more embodiments, alarm system control panel 306 can be configured to take into account user-supplied or automatically obtained (e.g., from a database, etc.) information about local watering ordinances, water restrictions, or other pertinent watering information when determining watering times. For instance, alarm system control panel 306 may avoid watering during periods of the day or year during which local watering ordinances prohibit watering, or may avoid watering while drought restrictions are in place.

In one or more embodiments, alarm system control panel 306 can be configured to consider the particular vegetation and/or soil types present when determining watering times and durations. For instance, a user may supply data regarding the particular type of vegetation and/or soil in each sprinkler zone. Then, using user-supplied or automatically obtained watering requirements information, alarm system control panel 306 can be configured to adjust watering times for each zone so that the particular vegetation in each zone receives an optimal amount of water. Alarm system control panel 306 can factor in weather conditions and/or soil types when making the adjustments.

In one or more embodiments, alarm system control panel 306 can be configured to track the service life of components of the sprinkler system. For instance, alarm system control panel 306 can track usage of components of the sprinkler system that are prone to wear, such as valves or sprinkler heads. Alarm system control panel 306 can be configured to compare the usage information with known service life data for the components to make maintenance recommendations. Alarm system control panel 306 can also be configured to send notification of regular maintenance, such as checking for clogged sprinkler heads, checking for rotten drip hoses, checking for proper adjustment of sprinkler heads, checking for vegetation overgrowth, performing annual purges of the irrigation system, etc.

In one or more embodiments, alarm system control panel 306 can also be configured to assist homeowners or business owners in the application of chemicals. For instance, alarm system control panel 306 can be configured to receive one or more remote sprinkler commands 312a indicating that the homeowner or business owner has recently applied or is about to apply a chemical, such as a herbicide, a fungicide, a pesticide, or a fertilizer. Alarm system control panel 306 can then utilize user-supplied or automatically obtained (e.g., from a database) information about recommended watering patterns that should coincide with the application of the chemical to appropriately adjust the watering schedule. Furthermore, alarm system control panel 306 can also be configured to automate that application of water-soluble chemicals. For instance, alarm system control panel 306 can be configured to control one or more chemical application devices that inject chemicals into the sprinkler system, and to adjust watering schedules as appropriate. Alarm system control panel 306 can also notify the homeowner or business owner when chemical applications will occur, when it is safe or unsafe to be present in the watering zones, and when chemical applications are recommended.

Optionally, alarm system control panel 306 may be programmed or otherwise configured to cause irrigation control system 300 or another auxillary system to apply chemicals to landscaping. When alarm system control panel 306 has been provided with information on the types of vegetation in each zone, alarm system control panel 306 can be configured to control chemical application such that chemicals are only applied to zones having the appropriate types of vegetation, or to notify the homeowner or business owner that a particular chemical application may harm the vegetation.

In one or more embodiments, alarm system control panel 306 can also be configured to respond to emergency situations by enabling all or part of a sprinkler system. For instance, if it is determined that a structural fire exists, the sprinkler automation module 306a can be configured to operate one or more sprinkler irrigation zones. Operation of selected sprinkler zones during a structural fire can help prevent the spread of the fire to bordering vegetation or structures, and may even reduce the rate of combustion of the burning structure. Furthermore, if sprinkler automation module 306a receives notice that a wildfire is in progress nearby, or that nearby structures are on fire, (e.g., from a signal from emergency response authorities, from local or remote user input, etc.), sprinkler automation module 306a can be configured to enable one or more sprinkler zones, thereby reducing the likelihood that a home or business, or the vegetation surrounding the home or business, will catch fire. In one or more embodiments, the sprinkler system may include one or more sprinkler zones that are specifically designed for fire suppression, and that would not normally activate except during a fire suppression situation. For instance, the sprinkler system may include zones that extend beyond normal landscaping that would provide an additional margin of safety for preventing spread of fire. In addition, the sprinkler system may include sprinkler zones integrated into structures.

The invention has been described in the context of a system architecture in which an alarm system control panel 306 maintains rules and watering schedules and in which alarm system control panel 306 sends commands to a control peripheral 304 for controlling sprinkler system control 302. It will be appreciated, however, that the architecture of irrigation-control system 300 can be modified without departing from the spirit and scope of this disclosure. For instance, sprinkler automation module 306a may, in one or more embodiments, be integrated into the control peripheral 304 instead of alarm system control panel 306. Thus, in one or more embodiments watering and scheduling decisions may be made at the control peripheral 304 instead of alarm system control panel 306.

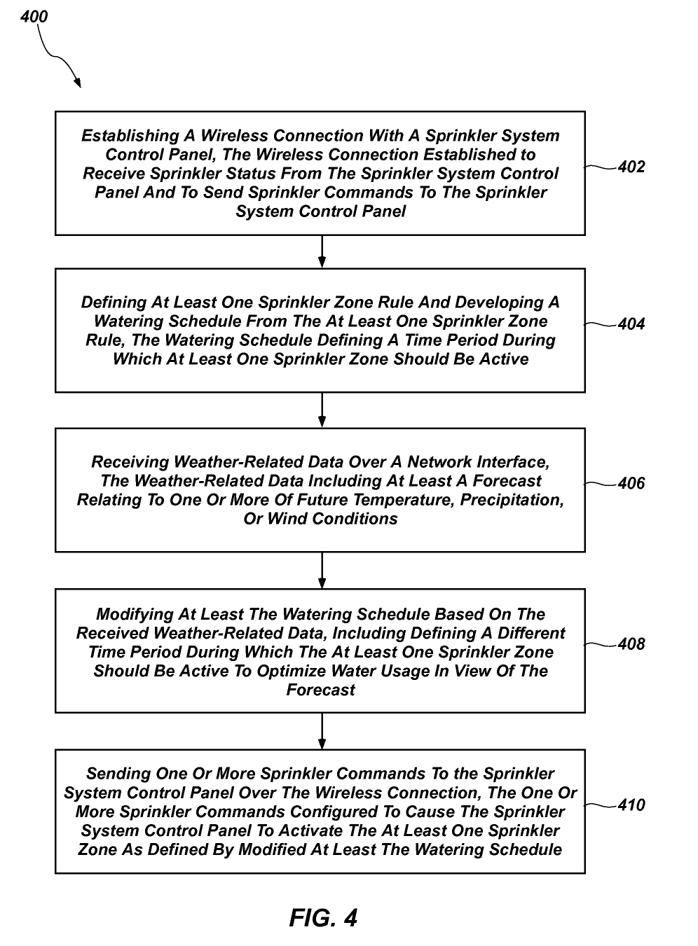

FIG. 4 illustrates a flowchart of an example method 400 for controlling a sprinkler system control panel with an alarm system control panel. Method 400 will be described with respect to the components and data of system 300 depicted in FIG. 3.

Method 400 includes an act of establishing a wireless connection with a sprinkler system control panel, the wireless connection established to receive sprinkler status from the sprinkler system control panel and to send sprinkler commands to the sprinkler system control panel (act 402). For example, alarm system control panel 306 can used wireless interface 306b to establish a wireless connection with wireless interface 304b of control peripheral 304. The wireless connection can be used to transmit sprinkler status 310a from sprinkler system control 302 to alarm system control panel 306, and to transmit sprinkler commands 310b from alarm system control panel 306 to sprinkler system control 302.

Method 400 also includes an act of defining at least one sprinkler zone rule and developing a watering schedule from the at least one sprinkler zone rule, the watering schedule defining a time period during which at least one sprinkler zone should be active (act 404). For example, sprinkler automation module 306a can define or develop zone rules that define watering times for the sprinkler zones. The zone rules at sprinkler automation module 306a can be defined with local user input (e.g., local sprinkler commands 318, etc.), remote user input (e.g., remote sprinkler commands 312a, etc.) and/or the zone rules at sprinkler automation module 306a can be based off of zone rules at sprinkler system control 302. From the zone rules, sprinkler automation module 306a can develop a watering schedule.

In addition, method 400 includes an act of receiving weather-related data over a network interface, the weather-related data including at least a forecast relating to one or more of future temperature, precipitation, or wind conditions (act 406). For example, alarm system control panel 306 can receive local weather data 316 over network 314. Local weather data 316 can include past, present, and future weather or climate data. Alarm system control panel 306 can also receive any other weather related data over network 314, such as local watering restrictions, vegetation information, soil information, etc.

Furthermore, method 400 includes an act of modifying at least the watering schedule based on the received weather-related data, including defining a different time period during which the at least one sprinkler zone should be active to optimize water usage in view of the forecast (act 408). For example, sprinkler automation module 306a can determine, based on local weather data 316 that at least one sprinkler zone should be operated during a time period not defined in the zone rules. This may involve operating the zone during additional time periods, preventing the zone from operating during a scheduled time period, altering a duration of a time period, etc. The decision to alter the watering schedule can be calculated to increase watering efficiency, to protect vegetation, to adapt to chemical application, etc. For instance, sprinkler automation module 306a can determine that a zone should be operated during a cooler period to make maximum use of the water applied, to forego watering do to an upcoming storm, to add additional watering cycles due to hot and/or dry weather, to apply water to prevent vegetation from freezing, etc.

Still further, method 400 includes an act of sending one or more sprinkler commands to sprinkler system control panel 306 over the wireless connection, the one or more sprinkler commands configured to cause sprinkler system control panel 306 to activate the at least one sprinkler zone 302a, as defined by at least the watering schedule (act 410). For example, the sprinkler automation module 306a can send one or more sprinkler commands via wireless interface 306b to the control peripheral. The control peripheral 304 can, in turn, cause these commands to be applied by the sprinkler system control 302.

Additional acts (not shown) can involve remote communication with a user. For instance, using network 314, sprinkler automation module 306a can send sprinkler system related data 312b to a remote computing device 308. Sprinkler system related data 312b can, in one example, indicate that the watering schedule has been modified due to the forecast. Sprinkler automation module 306a can also receive remote sprinkler commands 312a from remote computing device 308. Such commands can include, for example, commands instructing alarm system control panel 306 to override the modified watering schedule. In this circumstance, sprinkler automation module 306a can further modify the watering schedule in accordance override commands. As discussed previously, communication with remote communication devices 308 can include many forms of sprinkler system related data 312b and remote sprinkler commands 312a. For instance, communication can involve definition, review, or modification of zone rules; review of past watering patterns; definition of watering restrictions; definition of vegetation and soil types; and notification of chemical application, to name a few.

Embodiments of the disclosed subject matter can greatly enhance a homeowner or business owner's use of sprinkler systems. While conventional sprinkler system control panels can control sprinkler systems based on rules, and even based on detected rainfall, coupling control sprinkler systems with alarm system control panels can greatly simplify use of sprinkler systems, enhance their efficiency, and otherwise provide additional benefits such as adaptive watering based on present vegetation, adaptive chemical application, and even fire suppression.

As noted above, see reference to FIG. 2, system 202a may comprise any system which is suitable for automation. As another example, system 202a may comprise an HVAC system, which may include one or more devices associated with heating, ventilation, and air conditioning. In this example, system automation module 206a may store and manage one or more HVAC rules (i.e., settings, schedules, or both) at alarm system control panel 206. As will be appreciated, one rule may define at what temperature(s) an air condition unit is to be turned “on” or “off.” Similarly, another rule may define at what temperature(s) a furnace is to be turned “on” or “off.” As will also be appreciated, one or more rules may be dependent on a time of day. More specifically, for example, a temperature setting may be set to a lower temperature at nighttime versus daytime.

Furthermore, upon receipt of information (i.e., weather data) from weather data source 216, automation module 206a may be configured to prospectively adjust one or more settings of system 202a. As a more specific example, upon receipt of weather data indicating that temperatures may rise substantially in the future, automation module 206a may modify one or HVAC settings (e.g., turn on an air conditioning unit, raise a temperature at which an air conditioning unit is activated, decrease a temperature at which a furnace is activated, turn off the furnace, turn on a fan, etc.). Furthermore, in this example, automation module 206a may be configured to consider, for example, sunrise and sunset times or humidity values when adjusting one or more settings of system 202a.

Further, in this example, system automation module 206a may be configured to make a determination, due to historical averages, that a future period of time is likely to be hot. Based on this knowledge, system automation module 206a can increase one or more of the duration and the frequency of operation of an air conditioning unit to ensure a structure (e.g., a house) remains adequately cool. As another example, system automation module 206a may be configured to make a determination, due to a future weather forecast of severe cold, that a heater should be operated at an increased rate. One will appreciate, in view of the disclosure herein, that these are but a few examples of modifications to settings and schedules of an HVAC system that can be applied based on the weather data. Any modifications of settings and schedules of an HVAC system based on weather data fall within the scope of this disclosure.

As another example, system 202a may comprise a swimming pool system, which may include, for example, a heater, a filtration system, and a swimming pool cover. In this example, system automation module 206a may store and manage one or more swimming pool rules at alarm system control panel 206. Furthermore, upon receipt of information (i.e., weather data) from weather data source 216, automation module 206a may be configured to prospectively adjust one or more settings of system 202a. As will be appreciated, one setting of a swimming pool may define at what water temperature(s) a water heater is turned “on” or “off.” Furthermore, another setting may cause the pool cover to be closed if winds reach a certain speed. Accordingly, for example, upon receipt of weather data predicting high winds, automation module 206a may cause system control 202 to close pool cover of system 202a. Furthermore, in this example, automation module 206a may be configured to adjust a temperature setting of the pool, and possibly a hot tub, based on temperature forecasts.

As yet another example, system 202a may comprise a lighting system, such as a lighting system for a residence. In this example, automation module 206a may be configured to consider, for example, sunrise and sunset times when adjusting one or more settings of system 202a.

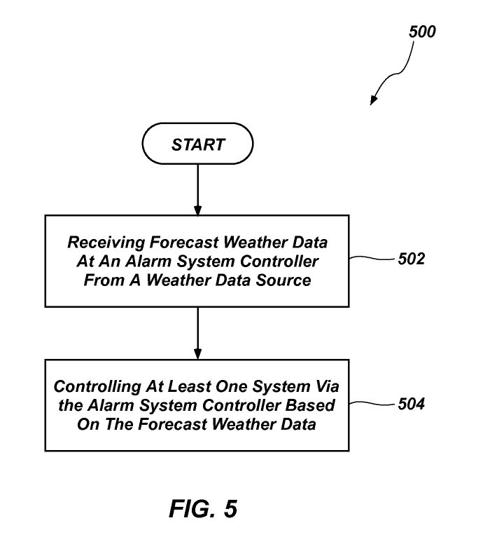

FIG. 5 illustrates an embodiment of a method 500 that includes receiving forecast weather data at an alarm system controller from a weather data source (act 502). For example, with reference to FIG. 2, alarm system control panel 206 may receive forecast weather data from weather data source 216. Method 500 further includes controlling at least one system via the alarm system controller based on the forecast weather data (act 504). As an example, system 202a, which may comprise, for example only, an HVAC system, a swimming pool system, or a sprinkler system, may be controlled based on the forecast weather data.

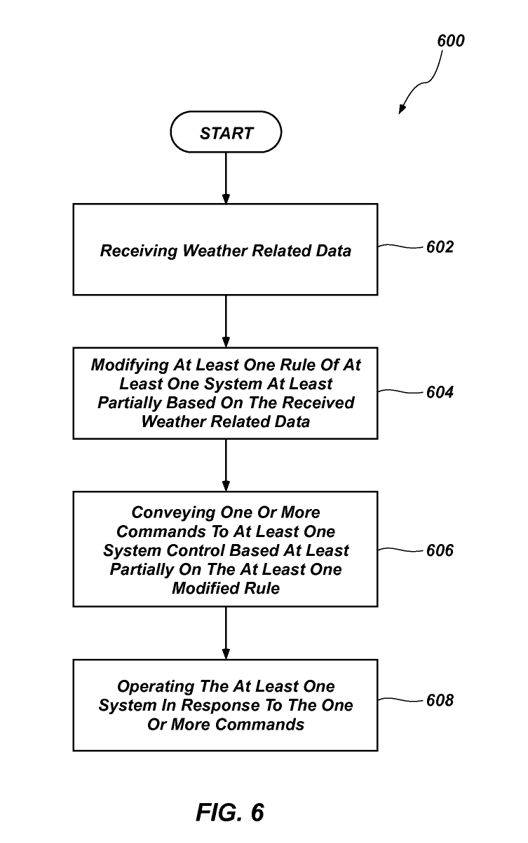

FIG. 6 illustrates a method 600, in accordance with another embodiment of the present invention. Method 600 includes receiving weather related data (act 602). Method 600 further includes modifying at least one rule of at least one system at least partially based on the received weather data (act 604). As an example, a watering schedule of a sprinkler system may be modified based on the received weather data. In addition, method 600 may include conveying one or more commands to at least system control based at least partially on the at least one modified rule (act 606). For example, alarm system control panel 206 may convey one or more commands to system control 202 to implement the modified rule. Moreover, method 600 may include operating the at least one system in response to the one or more commands (act 608). As an example, system 202a, which may comprise a sprinkler system, may be operated according to one or more commands sent to system control 202.

As will be appreciated by a person having ordinary skill in the art, embodiments of the present invention, as described herein, may enable for enhanced systems. For example, embodiments of the present invention may increase efficiency of a systems, reduce energy used by systems, conserve water, and increase comfort levels,

Although the foregoing description contains many specifics, these should not be construed as limiting the scope of the disclosed subject matter or of any claim, but merely as providing illustrations of some embodiments. Similarly, other embodiments may be devised which do not depart from the spirit or scope of the disclosed subject matter. Features from different embodiments may be employed in combination. The scopes of the claims are, therefore, indicated and limited only by their plain language and its legal equivalents, rather than by the foregoing description. All additions, deletions and modifications to the disclosed subject matter that fall within the meaning and scopes of the claims are to be embraced thereby.

What is claimed:

1. A method, comprising:
receiving forecast weather data at an alarm system controller from a weather data source; and
controlling at least one system via the alarm system controller based on the forecast weather data.

2. The method of claim 1, the receiving forecast weather data comprising receiving at least one of a forecast maximum and minimum temperature data, forecast cloud cover data, forecast humidity data, forecast precipitation data, and forecast wind data.

3. The method of claim 1, the controlling at least one system comprising controlling at least one of an HVAC system, a sprinkler system, a lighting system, and a swimming pool system.

4. The method of claim 1, the controlling at least one system comprising conveying one or more control signals to the at least one system.

5. The method of claim 1, further comprising receiving information indicating a status of the system.

6. The method of claim 1, the controlling at least one system comprising conveying one or more control signals to a system control for controlling the at least one system.

7. The method of claim 1, the controlling at least one system comprising conveying one or more commands from a remote computing device to the at least one system via the alarm system controller.

8. An alarm system control panel, comprising:
a system automation module to receive weather forecast data from a weather data source and manage one or rules for a remote system; and
an interface configured to transmit one or more commands for controlling the remote system according to the one or more rules.

9. The alarm system control panel of claim 8, further comprising a user interface for receiving local commands for defining the one or more rules.

10. The alarm system control panel of claim 8, the interface further configured to receive information indicating a status of the remote system.

11. The alarm system control panel of claim 8, the interface further configured to receive one or more remote commands from a remote computing device for defining the one or more rules.

12. The alarm system control panel of claim 8, the interface further configured to convey information indicating a status of the remote system to a remote computing device.

13. A control peripheral device, comprising:
a first interface configured for receiving one or more commands from an alarm system controller and transmitting a status of a system to the alarm system controller; and
a second interface configured for coupling to a system control for controlling the system in response to the one or more commands.

14. The control peripheral device of claim 13, the second interface configured to communicatively interface with the system control via a hard-wired serial interface.

15. The control peripheral device of claim 13, the system status comprising at least one of current setting information, historical runtime information, system control data, and system hardware information.

16. The control peripheral device of claim 13, the second interface further configured for receiving the system status from the system control.

17. A method, comprising:
receiving weather related data;
modifying at least one system rule at least partially based on the received weather related data;
conveying one or more commands to at least one system control based at least partially on the at least one modified system rule; and
operating the at least one system in response to the one or more commands.

18. The method of claim 17, the modifying comprising modifying at least one of a schedule and a setting of the at least one system.

19. The method of claim 17, the receiving weather data comprising receiving at least one of temperature data, wind speed and direction data, precipitation data, humidity data, sunrise and sunset data, air quality data, ozone level data, and cloud cover data.

20. A control system, comprising:
an alarm system controller for receiving weather data from a weather data source and conveying one or more commands for controlling an operation of one or more systems in response to the weather data;
a system control for receiving the one or more commands from the alarm system controller and controlling the one or more systems in response thereto.

21. The system of claim 20, further comprising a control peripheral device, comprising:
a first interface configured for receiving one or more commands from the alarm system controller and transmitting a status of a system to the alarm system controller; and
a second interface configured for coupling to the system control for controlling the system in response to the one or more commands.

22. The control peripheral device of claim 20, the one or more systems comprising one or more of an HVAC system, a sprinkler system, a lighting system, and a swimming pool system.

23. A computer-readable storage medium storing instructions that when executed by a processor cause the processor to perform instructions, the instructions comprising:
receiving forecast weather data at an alarm control panel from a weather data source; and
controlling at least one system via the alarm control panel based on the forecast weather data.

24. An alarm system control panel that interfaces with a sprinkler system control, the alarm system control panel comprising:
a wireless interface configured to establish a connection with a sprinkler system control and to transfer sprinkler system related data through the connection, including:
receiving sprinkler status from the sprinkler system control, and
sending one or more sprinkler commands to the sprinkler system control;
a network interface configured to receive weather-related data from a network; and
a sprinkler automation module configured to manage one or more sprinkler zones operated by the sprinkler system control.

25. The alarm system control panel of claim 24, the sprinkler automation module configured for:
receiving the sprinkler status from the sprinkler system control via the wireless interface;
maintaining one or more of at least one sprinkler zone rule and a watering schedule;
modifying one or more of the at least one sprinkler zone rule and the watering schedule based on the weather-related data received from the network; and
sending the one or more sprinkler commands to the sprinkler system control via the wireless interface, the one or more sprinkler commands configured to cause the sprinkler system control to implement the modified at least one sprinkler zone rule or the modified watering schedule.

26. The alarm system control panel of claim 24, wherein the weather related data comprises at least one of past weather data, present weather data, and future weather data.

27. A method comprising:
establishing a wireless connection with a sprinkler system control, the wireless connection established to receive sprinkler status from the sprinkler system control and to send sprinkler commands to the sprinkler system control panel;
defining at least one sprinkler zone rule and developing a watering schedule from the at least one sprinkler zone rule, the watering schedule defining a time period during which at least one sprinkler zone should be active;
receiving weather related data over a network interface, the weather related data including at least a forecast relating to one or more of future temperature, precipitation, or wind conditions;
modifying at least the watering schedule based on the received weather related data, including defining a different time period during which the at least one sprinkler zone should be active to optimize water usage in view of the forecast; and
sending one or more sprinkler commands to the sprinkler system control panel over the wireless connection, the one or more sprinkler commands configured to cause the sprinkler system control panel to activate the at least one sprinkler zone as defined by modified at least the watering schedule.
